(19) United States
(12) Patent Application Publication
(10) Pub. No.: US 2010/0008551 A9
(43) Pub. Date: Jan. 14, 2010

(54) Using handwritten information

(76) Inventors: Ilya Schiller, Brookline, MA (US); Arkady Pittel, Brookline, MA (US); Alec Segal, Cambridge, MA (US)

Correspondence Address: FISH & RICHARDSON PC, P.O. BOX 1022, MINNEAPOLIS, MN, 55440-1022, US

(21) Appl. No.: 09/832,340

(22) Filed: Apr. 10, 2001

Related U.S. Application Data
(63) Continuation-in-part of application No. 09/698,471, filed on Oct. 27, 2000, now abandoned.
Application No. 09/698,471 is a continuation-in-part of application No. 09/376,837, filed on Aug. 18, 1999, now Pat. No. 6,577,299.
(60) Provisional application No. 60/195,491, filed on Apr. 10, 2000.
(60) Provisional application No. 60/230,912, filed on Sep. 13, 2000.
(60) Provisional application No. 60/096,988, filed on Aug. 18, 1998.
(60) Provisional application No. 60/142,200, filed on Jul. 1, 1999.
(60) Provisional application No. 60/142,201, filed on Jul. 1, 1999.
(60) Provisional application No. 60/195,491, filed on Apr. 10, 2000.
(60) Provisional application No. 60/161,752, filed on Oct. 27, 1999.

(51) Int. Cl. G06K 9/00

(52) U.S. Cl. 382/119; 382/187

(57) ABSTRACT

Handwriting data is received electronically from a remote user at a handwritten-information server, and the handwriting data is processed in accordance with instructions provided to the server by the user, e.g. by forwarding the handwriting data to a specified destination identified by the user.

### BACKGROUND

This application claims the benefit of the filing dates of U.S. Provisional Patent Application Ser. No. 60/195,491, filed Apr. 10, 2000, and U.S. Patent Application Ser. No. 09/698,471, filed Oct. 27, 2000, both incorporated here by reference. This application is a continuation in part of U.S. Patent Application Ser. No. 09/698,471, filed Oct. 27, 2000.

This invention relates to using handwritten information.

A variety of devices have been used to capture handwritten information, including clay tablets and styli, pencil and paper, digitizing pads, and electronic pens.

Personal digital assistants, such as PalmPilot, also use handwriting as a mode of input.

### SUMMARY

In general, in one aspect, the invention features a method that includes receiving handwriting data electronically from a remote user at a handwritten-information server, and processing the handwriting data in accordance with instructions provided to the server by the user.

Implementations of the invention may include one or more of the following features. The handwriting data is generated using a handwriting device (e.g., an electronic wireless pen) at the location of the remote user. Handwriting recognition is performed at the site of the remote user or at the handwritten-information server. At the location of the remote user, an electronic file is formed representing the handwritten information. The handwritten information is transmitted wirelessly to a communication device. The electronically captured handwriting is then transmitted from the communication device to the handwritten-information server.

The handwriting data includes information identifying a destination of the handwriting data. The processing of the handwriting data includes forwarding it to a destination, for example, by sending the handwriting data in FAX format or as an email attachment or in a body of an email.

In general, in another aspect, the invention features a method that includes (a) using a tracker attached to a mobile personal digital assistant having wireless communication capability to track handwriting done on a writing surface in the vicinity of the personal digital assistant, (b) sending handwriting data representing the handwriting wirelessly from the personal digital assistant to a server, and (c) providing services to a user from the server with respect to the handwriting data.

In general, in another aspect, the invention features a method that includes (a) storing, in a server, handwriting information provided wirelessly from mobile devices, and (b) communicating the handwriting to destinations based on instructions provided by users.

In general, in another aspect, the invention features a method that includes storing in a server handwriting information received wirelessly from mobile devices, and providing an interactive user interface on a screen of a mobile device to enable a user to control functions applied to the handwriting information.

In general, in another aspect, the invention features a method that includes (a) capturing handwriting of a name of an addressee of a message as handwriting data representing motion that occurred during the handwriting, (b) communicating the handwriting data to a server, and (c) at the server, determining the name from the handwriting data using information stored in a database.

Implementations of the invention may include one or more of the following features. The user is asked for confirmation of the located address. The message is sent to the located address. The database includes information provided by a user, the information in the database linking names with corresponding addresses.

In general, in another aspect, the invention features a method that includes from a server, communicating handwriting data to remote user devices, the handwriting data for each of the devices being formatted according to display capabilities of the remote user device.

In general, in another aspect, the invention features a method that includes (a) receiving at a server handwriting data representing a signature of a user of a remote device, (b) verifying the signature based on handwriting data associated with the user and stored on the server, and (c) authorizing a transaction based on the verification of the signature.

Implementations of the invention may include one or more of the following features. The authorizing includes providing an authorization to a third party. The transaction is associated with a financial account of the user. The receipt of the handwriting data occurs after terms of the transaction have been resolved. The authorization is also based on a unique identifier of a pen that is used to write the signature. The transaction may be authorized based also on voice or speech recognition and on a time stamp.

In general, in another aspect, the invention features a method that includes (a) receiving and storing at a server handwriting information that is created by users at remote locations and communicated electronically to the server, (b) electronically performing services with respect to the stored information, and (c) charging the users for the services performed.

In general, in another aspect, the invention features a method that includes (a) receiving, at a server, handwriting data from a pen and a pen identifier, (b) storing, at a server, an indication that the pen is in the possession of a person not authorized to use it, (c) in response to the received handwriting data and pen identifier, determining that the pen is not being used by an authorized person, and (d) taking an action in accordance with the result of the matching.

In general, in another aspect, the invention features, a method that includes (a) receiving electronic handwriting data created by a user's handwriting, (b) receiving instructions (e.g., from a handwriting instrument) indicating visible qualities (e.g., color) to be associated with respective portions of the handwriting, and (c) manifesting the handwriting in a visible form in which each of the respective portions of the handwriting is manifested in accordance with the indicated visible qualities.

In another aspect, the invention features a method that includes (a) associating unique identifiers with respective electronic handwriting devices that are useful in generating handwriting data, (b) in a server, storing the handwriting data and storing associations between the unique identifiers of the devices and registered unique identifiers of respective users, and (c) at the server, controlling use of the handwriting data based on matching stored pairs of user identifiers and device identifiers to confirm that the purported user of a device used to generate the handwriting data is the registered user of the device.

In general, in another aspect, the invention features apparatus that comprises a mobile electronic device that includes (a) a communication facility configured to communicate with a remote location, and (b) a tracking facility configured to track handwriting motion of a stylus on a surface in a vicinity of the mobile electronic device.

Implementations of the invention may include one or more of the following features. The mobile electronic device may include a mobile telephone. The mobile electronic device has a housing and the tracking facility is incorporated within the housing or is attached to the housing. The device has a receptacle for a stylus.

Other advantages and features will become apparent from the following description and from the claims.

### DESCRIPTION

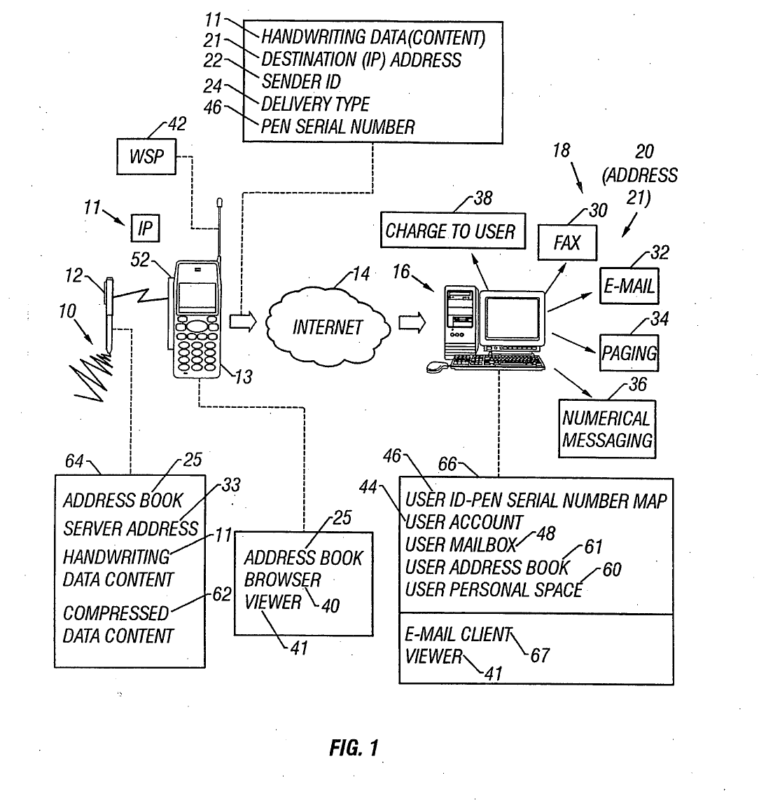

(FIG. 1 shows a block diagram of a handwritten information processing system.

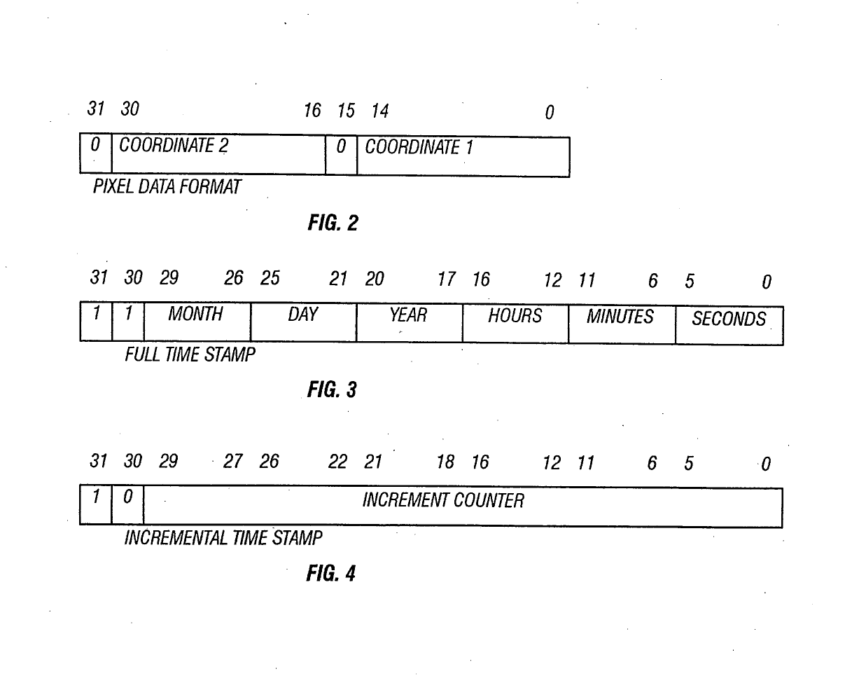

FIGS. 2 through 4 show word formats for handwriting data.

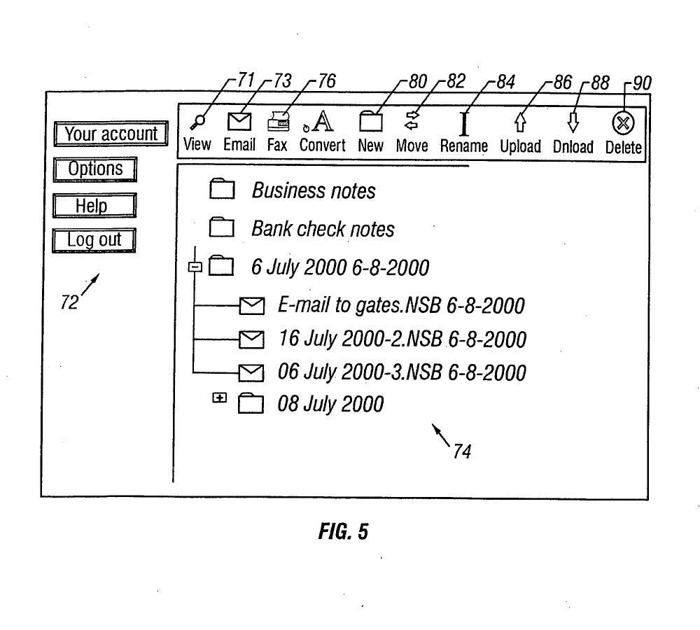

FIG. 5 shows a user interface.

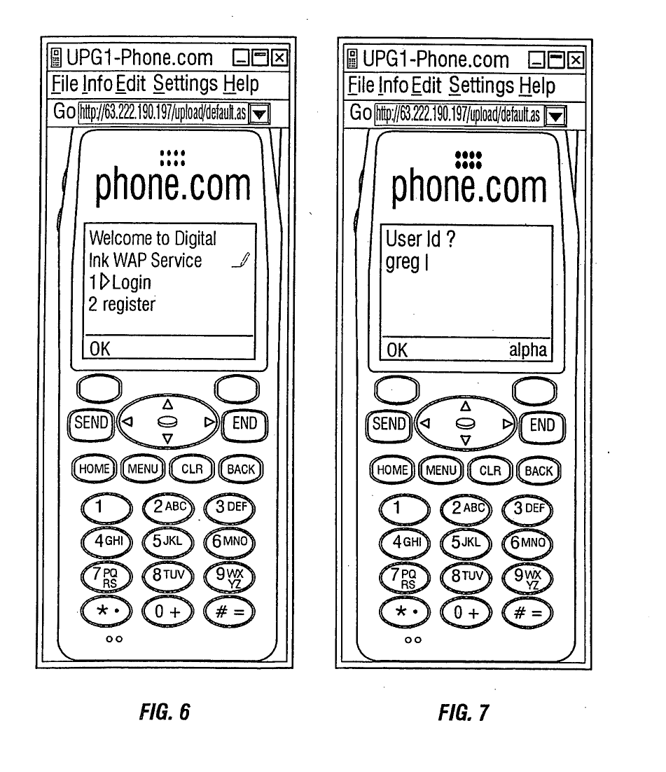

FIGS. 6 through 11 show user interface screens on a cell phone.

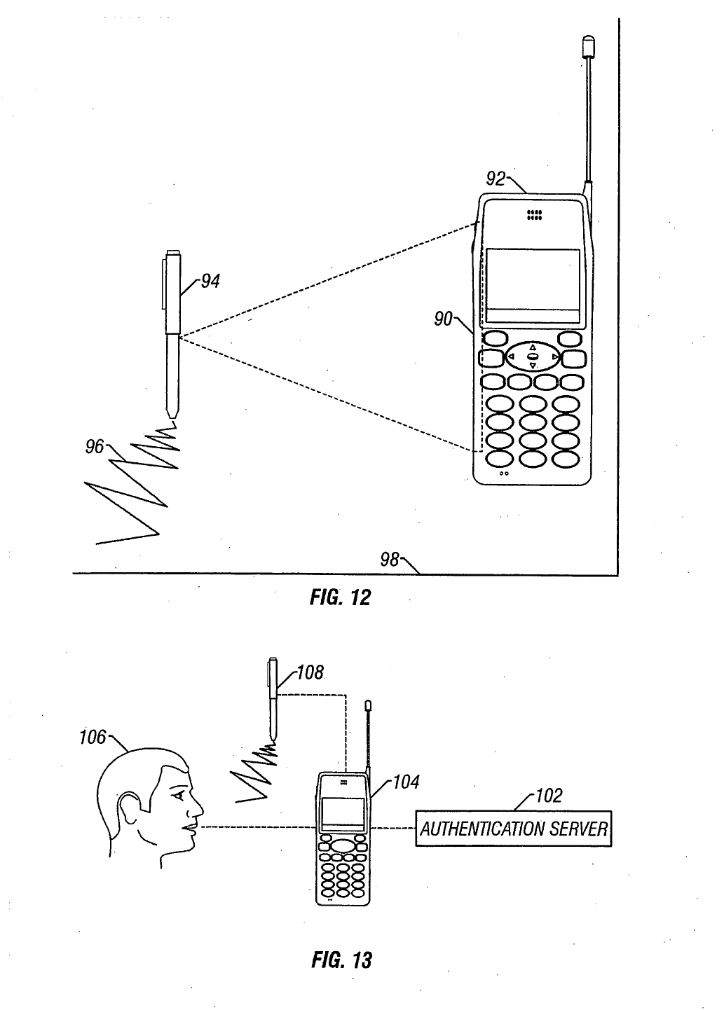

FIG. 12 shows a cell-phone and pen.

FIG. 13 shows an authentication system.

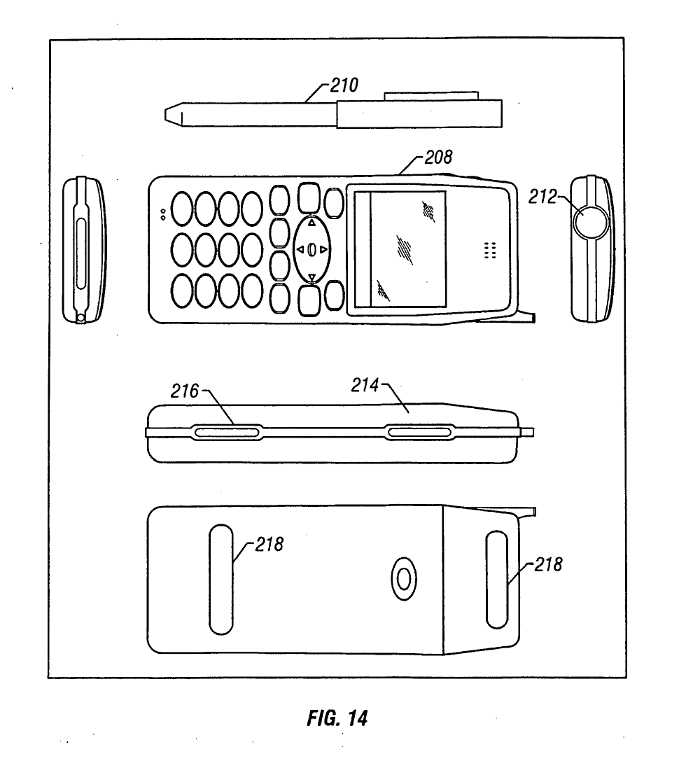

FIG. 14 shows six sides of a cell phone.

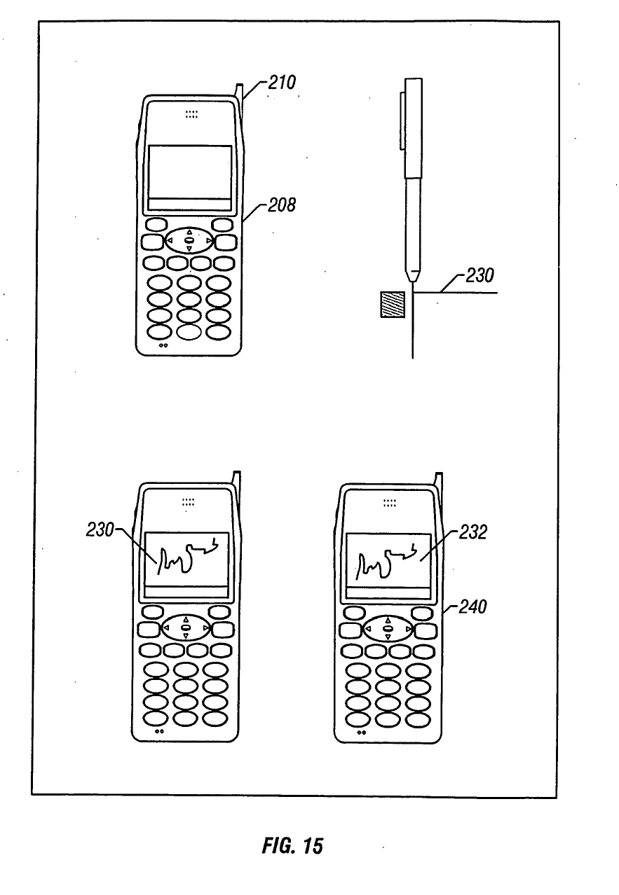

FIG. 15 shows six steps in an example use of a pen-equipped cell phone.)

As shown in FIG. 1, handwritten information (such as notes and pictures) 10 produced by a user using a pen 12 is converted to handwriting data 11 and sent through a cellular phone 13 and the Internet 14 to a handwritten-information server 16.

The pen could be any device by which the motion of a user's hand can be captured as data, including electronic pens, digitizing tablets, mouses, and trackballs, to name some. The pen could be of the kind that can be tracked by nearby tracking devices such as the pens described in U.S. patent application Ser. No. 60/096,988, filed Aug. 18, 1998; Ser. No. 60/142,200, filed Jul. 1, 1999; and Ser. No. 60/142,201, filed Jul. 1, 1999, and Ser. No. 09/698,471, filed Oct. 27, 2000, all incorporated by reference. The tracking device can be housed in a cap of the pen, in a pen well, or in (or on) the cell phone or similar device. We use the word pen broadly to refer to any of these.

The handwriting data (representing the handwriting motion of the pen) can be encoded in a variety of formats. The encoding can include data compression. For purposes of viewing the handwriting later through a web browser, a free browser plug-in, capable of decoding the encoded data, can be downloaded from a server.

Handwriting and handwritten information may include written letters, text, words, notes, numbers, sketches, and any other indicia that can be formed by motion of a user's hand.

The cell phone could be replaced by any similar kind of device that permits communication with a remote server, either wirelessly or through a wired connection. For example, the device could be any wireless Internet-ready device such as a PalmPilot or other personal digital assistant, a laptop or desktop computer, or a wired telephone set. Dial-up devices could reach the server through a phone or a modem. Any Internet-ready wireless or dial-up device that has limited ability to capture and convey handwriting data can be supplemented by a wireless portable electronic pen, pad or scanner that can beam handwriting data to the Internet-ready device.

When the device 13 communicates with the server, the handwriting data 11 (the content) that was sent from the pen (or the tracker, depending on the implementation) is supplemented with a sender ID 22 (also typically sent from the pen), an identifier for an intended type 14 of delivery or method of communication (e.g., fax, e-mail, paging, or numerical message) 24, and a destination (e.g., IP) address 21.

The desired destination address (such as a telephone number) may be entered at the cell phone keypad or may be provided from an address book 25 maintained in the pen or in the cell phone, allowing the user to select a destination address or fax number, for example. The destination address may also simply be handwritten into the message for later extraction.

The server 16 processes the handwriting data 11, extracts the destination address 21 (using handwriting recognition, if the address has been handwritten) and converts the handwriting data to a fax message 30 or to an e-mail attachment 32, or uses handwriting recognition to send a message as an ASCII e-mail, or generates a paging message 34 or a numerical message 36.

The handwritten-information server provides a wide variety of services for the user with respect to the handwriting data. One service is to process the handwriting data and then forward it 18 by email or FAX to a destination 20 the address 21 of which has been specified by the user. The user may be charged 38 for the delivery.

In some implementations, the connection to the handwritten-information server is originated by the cell phone, which also provides the destination addresses and ID information about the user. In other implementations, the pen itself originates the connection and provides the destination address and ID.

In the first of these two modes, the user works in a browser 40 running on the cellular phone to connect through the Internet 14 to the handwritten-information server 16. The browser could be a standard Wireless Application Protocol (WAP) browser or another browser.

Through the browser, the user specifies the destination address 21 for the handwriting data and the mode of delivery or communication in which the handwriting data should be sent (for example, FAX, email, voice). The user ID could also be provided automatically to the handwritten-information server by the user's wireless service provider 42 (e.g., ATT, Sprint, Air Touch) or by the user when he logs onto the handwritten-information server.

The handwritten-information server locates the user's account 44 based on the user's ID and then retrieves a serial number 46 of the pen from a pre-stored list that maps user IDs to pen serial numbers. The list is generated from information provided by users when they register for the service or when they log on. Each pen has a unique serial number that is assigned, for example, by the manufacturer or distributor.

The pen serial number 46 is provided to the server along with the handwriting data each time the pen sends data. The handwritten-information server watches for handwriting data coming from a pen that has the serial number associated with the logged on user.

The user can “talk” to the server by other mechanisms than a browser, including speech that is recognized automatically at the server end or touch-tone (DTMF) sequences.

Once the user's browser has setup a planned transfer with the handwritten-information server, the pen can connect through a serial or infrared interface 52 of the cellular phone to the handwritten-information server (or, if the tracker is in or on the phone, through a wired connection within the phone) and submit the handwriting data. For this purpose, the server's address 33 (IP or DNS) is pre-stored in the pen's memory as part of the configuration settings.

In implementations in which the tracker is not part of or attached to the phone, the pen 12 has a beaming capability that enables it to convey the handwriting data to the cell phone using an infrared link (IrDA), an RF link (bluetooth) or a similar mode of communication. Alternatively the communication could occur directly between the pen/tracker and a remote server using a wireless connection to the Internet, such as a connection that conforms to the IEEE 802.11 protocol. In that case, the pen/tracker could be supplied with an 802.11-compliant chip.

If the service provider 42 that serves the cell phone does not provide Internet data connectivity to the handwritten-information server, the pen dials (through the cell phone) any Internet Service Provider (ISP) and opens a socket connection to the handwritten-information server, or dials the handwritten-information server directly. In the case of an Internet connection, the pen uses SLIP or PPP protocol to transfer the handwriting data through the cell phone. In the case of a direct connection to the handwritten-information server, the communication can be done using any protocol negotiated between the pen and the server.

After receiving the handwriting data, the handwritten-information server preprocesses the data, including reconstructing the handwriting from the angle/position sensor data, and converts the handwriting data to the appropriate format (e.g., FAX, email attachment) as specified by the user and sends it to the specified destination in FAX, email attachment, or other format. In other examples, the handwriting can be included directly as handwriting in the body of an email.

In some implementations, the handwriting data is processed without regard to the “content” of the handwriting and forwarded to the destination. In other implementations, some or all of the content of the handwritten information may be extracted using handwriting recognition algorithms. The recognition can be performed at the pen, at the cell phone, or at the handwritten information server.

The recognized content could include, for example, the words of a handwritten message. In that case, the handwritten-information server may send the text of the message in the body of an email or in a synthesized voice message, or may store the message in character format for later use. The content could be written using standard alphanumeric characters or special machine-readable signs.

The recognized content could also include the destination address in the form of a FAX number or an e-mail address written by the user on paper. In that case, it is possible to sidestep the need for a browser on the cell phone and enable the pen to communicate the handwriting data directly through the cell phone to the handwritten-information server. The same thing could be done without the need for handwriting recognition using a user interface display or buttons on the pen.

In some cases, the destination address may be derived from the written information without requiring time-consuming handwriting recognition of the content of the handwriting. Instead, the handwriting can simply be matched with pre-stored handwritten versions of addressees, a process that is faster and simpler.

In addition to forwarding handwriting data (representing, e.g., notes, drawings, text) as e-mail attachments or FAX, the handwritten-information server can provide a range of other products and services.

The handwritten-information server can assist pen users in other aspects of communication. For example, the handwriting data received from the pen may be stored in user mail boxes 48 maintained on the handwritten-information server for later retrieval or forwarding. The handwriting data may be posted on the Internet 14. The handwritten-information server may store information such as addresses, phone numbers, or to do lists in a user's personal space 60. The pen may also request the handwritten-information server to provide information on the user's account 44, perform computations that on-pen processors cannot do, and set or re-set preferences on the pen or on the handwritten-information server.

The system can be operated in a model in which the electronic pen is provided free or nearly free to users.

A more detailed implementation discussion follows.

Once the pen is in communication with the cell phone, the handwriting data content of the penis memory 64 is automatically transmitted to the server 16. The server receives the compressed data content 62 and the header information (sender ID and delivery type) from the pen and stores them in its database 66.

The server then updates the user account (by storing the received data and the delivery type) and waits for further instructions that will come from the cell phone or a PC-based Internet connection on what to do with the received data. The server may send an acknowledgement of receipt to the pen and may cause the pen to erase the message according to preferences defined by the user, for example, a preference to erase when sent or to erase within three days.

The pen captures the handwriting data 11 as x, y vectors. In some cases the x, y vectors could be supplemented by additional data representing pen pressure (useful for determining line thickness), pen tilt (for accuracy), and virtual color. A virtual color or other handwriting characteristic can be indicated by the user through a button click on the pen or by writing an appropriate codeword. Thus, the user could indicate that the first sentence in memo should be construed to be in red and the second sentence in blue, even though the actual ink color of the pen is black. When the handwriting is later manisfested to a viewer, say on a display of a handheld device, each portion of the handwriting (or the derived characters) can be displayed in the indicated color.

As shown in FIG. 2, each of the vectors is captured as a two-byte word. Fifteen bits of each byte represent one of the coordinate values in a two-coordinate system. The coordinate values are either real paper coordinates with .1 mm resolution or are sensor sub-pixel coordinates. The maximum value for a paper coordinate is 3000. The maximum value for a sub-pixel coordinate is 1024 times a scale factor between 4 and 16.

The successive coordinates for handwriting on a page are captured in successive frames and stored together. A timestamp is inserted in the beginning of the page and each time the pen is lifted from the paper. The system detects when the pen is lifted or again contacts the paper by detecting the presence or absence of the pen in successive frames. The timestamp can be kept in either a full format or an incremental format at shown in FIGS. 3 and 4. In either case the most significant bit distinguishes the time stamp word from a vector word. When a new page is started, a full timestamp is inserted before the first valid pixel word. Subsequent timestamps are incremental. An incremental timestamp stores only the number of frames since the last full timestamp. The frame frequency is a settable parameter.

A full timestamp can also be inserted anywhere within a page. Incremental timestamps will show incremental counter relative to the last full timestamp.

Each page is stored in a separate file. There is no need for an end of page mark. A previous page is compressed and stored before new page acquisition is started.

After capture, the vector data is pre-processed and compressed using a smoothing and variable length coding algorithm. The compressed data is stored in the pen's local memory 64 until the pen is connected to a cell phone. When that occurs, the server address 21 and compressed data 62 are transmitted. If transmission is successful, the content in the pen's memory can be deleted. If transmission fails, a warning light on the pen indicates the failure.

After the server receives data from the pen, the server decompresses the data and reads the header information, which includes the pen serial number and the user ID. The server checks if the ID is valid. If so, the server stores the decompressed data in the user's mailbox 48 or other area in the database. The stored decompressed files are then available to the user.

The user may connect to the server at any time using a WAP phone or a PC with a World-Wide Web Internet connection. Once connected, the user can manage his account and his mailbox and arrange for any desired use of the handwriting data that he has stored.

For example, if the user connects using a WAP phone, the user may instruct the server to perform one of the following actions:
1. E-mail any or all of the files to one or more specified e-mail addresses. The file can be sent as an attachment (or, as previously mentioned, directly as handwriting in the body of the email) in either jpeg or another format.
2. Fax any or all of the files to one or more specified fax numbers.
3. Delete or rename one or more of the files.
4. Perform handwriting recognition on one or more of the files.
5. View one or more of the files.

For example, when a user connects to his account, the server verifies the user's password and responds with a message such as:

Last upload on Jul. 10, 2000 with 6 files/pages. Select appropriate option:
1. send e-mail
2. send fax
3. delete
4. rename

When option 1, 2, 3, or 4 is selected, the server asks the user to select the files, for example if 1 is pressed, the reply message may be:

Which files/pages to e-mail?

Press 0 to e-mail all pages or select a page number followed by a pound sign as many times as needed.

Press pound sign one more time to complete or star to cancel.

After specifying which pages, the user specifies a recipient's fax number or e-mail address in response to a message that reads:

Please input destination e-mail address using keys or the bookmark.

The user dials a fax number or punches an e-mail address using buttons on the cell phone or using pre-stored numbers or bookmarks on the cell phone.

To make use of the features available on the server, the first time a user connects, he is required to register for an account and provide the following information:
user name
user password
pen serial number (from the product box or CD-ROM)
user name
company name
address
telephone
e-mail
fax
cell phone number
phone type (pull up menu)
phone service provider (pull up menu)

If the pen serial number is determined to be valid (because it matches a pen serial number previously stored at the server in connection with the sale and distribution of the pen), the user is registered.

For each new user, the server (1) creates an account 44 and associates it with the pen serial number and the user ID and (2) sets up serial connection parameters to handle pen-to-cell phone connections based on the specific type of cell phone and cell phone provider the customer is using.

The server can be used as a central location to store much or all of a user's handwritten notes and information. Because the user has access to the handwriting data from anywhere at anytime, he can use handwritten notes in a wide range of new ways, treating the central server as a personal notebook that is accessible at any time from any location.

For example, a user could store a handwritten map of a location where a friend should plan to meet him in an unfamiliar city. The user sends the map to the friend's cell phone using the server's functionality.

Server User Interface

As shown in FIG. 5, the main user's screen as it might appear on a display has three areas: on top are the icons 70 that perform allowable functions on user's files, on the left are the buttons 72 that provide general information, change options, and logout, and on the right is a list 74 of user's folders and files.

The icons on the top are:
View 71—enables a user to display and perform editing on a handwritten file/page.
E-mail 73—enables a user to email a file.
Fax 76—enables a user to fax a file (faxing is through a third party arrangement that may involve usage charges).
Convert 78—enables a user to have handwriting recognition performed.
New Folder 80—enables a user to create a new folder.
Move 82—enables a user to move a file from one folder to another.
Rename 84—enables a user to rename a file from a name that is automatically applied at the time of
upload (e.g., <Date Month Year_x.scb>where x is a file/page number for example: 08july2000_{—}1.scb)
Upload 86—enables a user to send a file from a local disk to the server.
Download 88—enables a user to send a file from the server to the local disk.
Delete 90—enables a user to permanently remove a file from the server.

E-mail

Invoking the e-mail option requires the user to specify a destination e-mail address(es). The server provides an e-mail client 67 with all necessary e-mail attributes.

The user's email list 61 on the server could be synchronized with other contact lists maintained by the user. In a simpler approach, there is no synchronization. Instead, the user types e-mail addresses on e-mail that is originated by the user, or the file to be sent could be downloaded to the user's computer where his resident contact list 25 could be used for e-mail addressing.

Viewing

When the user triggers the view feature, a viewer 41 in the form of a plug-in running on the server or on the device 13 is invoked. The viewer allows the user to perform simple manipulation of the handwritten image displayed. The manipulation includes erasing blocks of text, drawing free lines, allowing typed annotations, and selecting part of the image for cut and paste.

Account Maintenance

The buttons 72 on the left of the display are:
Your account—enables the user to review his account information, usage, storage size, records of e-mails and faxes, and records of services and to change or update user information, cell phone number, or cell phone provider.
Options—enables the user to specify user options such as selecting an e-mail attachment default format (jpeg or another format), automatically deleting user files after so many days, and others.
Help—enables the user to get help on how to use the server's features.
Logout—enables the user to sign off the session

File List

The list of user files and folders 74 is a main part of the display that contains a hierarchical view of a user's collection of handwritten data in a format similar to Microsoft Windows Explorer. The user is enabled to sort his files and folders by name or date.

Viewer

The viewer 41 is a program that allows users to open files that contain handwritten data. The handwritten data files are stored in the format illustrated in FIGS. 2, 3, and 4. Compression is used to reduce the size and improve security of handwritten files.

The viewer is a PC-executable file that decompresses and displays such files. The viewer size (in bytes) should be as small as possible because it needs to be downloaded frequently or included along with data files efficiently (i.e., self-executable handwritten files). The viewer provides the following features:
Double clicking on a file shown on the interface of FIG. 5 launches the viewer and opens the file.
The viewer re-constructs handwritten text in a scrollable window.
The windows can be merged or split.

The viewer Window includes a menu bar with the following menus:

File

Open ...
Close ...
Send as e-mail ...
Save ...
Save as ... - save as jpg, gif
Download - Download directly to a

connected USB device

Connect - connect directly with a

USB device for real-time display

Exit

Edit (works on selected area)

Undo
Copy
Cut
Paste
Delete
Select All

Pen (pen tool that allows users to mark
the page)

Width
Color
Change Color

View

Single page
All pages
Zoom

Up
Down

Window

Next window
Arrange All
Merge windows
Split windows
“Name of the active Window”

In addition a tool bar can be created with most of the features described in the menu.

Sending Messages Over the Cellular Phone Connection

There are different ways of specifying destination address and communication methods. The destination address can be a cellular phone number for sending graphical messages (using alarm notification capabilities of WAP), an e-mail address, or a FAX number. Similarly, the communication protocol can be for a graphical message, an e-mail, or a FAX.

Destination and communication data can be entered automatically or in a way that is natural for the user, by writing it in the top section of the page that is being sent, with manual confirmation, correction, and entering of data when automatic mode does not work.

For example, the user may write: “Message to John Smith” at the beginning. The addressee can then be derived either by brute-force handwriting recognition or by a simpler matching process against stored samples, as mentioned earlier.

The user can select pen parameters (using the Viewer) to specify whether to transmit data to a recognized address without confirmation, or to require confirmation in any case. By default, confirmation should be required for security.

After the handwritten message is uploaded to a server through a cellular phone, the text in the top section of page is parsed and recognized. If the destination address and communication method are legible and match a corresponding address and method stored on the server (for example, the address matches the address of a person in the address book, and the method is recognized), then the message is sent to the user for confirmation: “Message for John Smith?”

If confirmation is received, the message is sent to the destination with a confirmation to the user on the cellular phone: “SMS has been sent to John Smith”.

If the name or method is not recognized, the message is sent back to the user of the cellular phone for confirmation and correction using manual keys. The same is done if two or more people are found with the same name. Then the user scrolls on the cellular phone display and confirms the name to be used. The same is done if the method, SMS, e-mail or FAX is not recognized.

The name that is associated with cell or FAX number or e-mail address or the method of communication can be entered using keys on the cellular phone. Manual entering of data can also be done in a separate connection to the server when navigation on the server is done using WAP protocol.

Selection of Type of Communication, Address and Name of Recipient

Handwritten text received at the server is searched for special attributes such as “Message to”, “E-mail to”, or “FAX to”.

Text following these attributes is recognized and matched with names in the user's server-stored address book. First name, nickname, last name, or combinations may be used and even recommended to user for better recognition.

The second line will have a subject that will be recognized and kept as a name of the file for searching of messages. For example:
Message to John Smith
Subject Holiday Party

Specific words in the document can be circled, and those words will be recognized and also used for search purposes.

Messages may consist of several cell pages that are scrollable on a cellular phone.

Compression for display on the cell phone screen may be limited by minimum size of letters. Horizontal scrolling may also be used, and text may be broken left to right as well as top to bottom.

For example, written text appears on paper as:

I am coming back from Miami, but had to make a stop at JFK in NY.

I will be back in office this afternoon and talk to you about my ideas.

On the phone screen, the text would be shown as:

I am coming back from Miami, but had to make a stop at JFK in NY. I will be back in office this afternoon and talk to you about my ideas.

Some Uses

Messages and e-mails can be sent by specifying a name from the user's address book 61 stored on the server and can be synchronized with user's contact lists such as Microsoft Outlook. For example, if a user handwrites

Send to: David

the software on the server searches in the user's address book, matches David with David Smith, finds David Smith's e-mail address: dsmith@aol.com, and sends the e-mail to David. Handwriting recognition need only find the match on the limited list of names in the user's address book.

Messages and e-mails can be formatted to suit a user's device. The server thus provides device independence for the data that is to be delivered. A message being delivered to a cell phone will be converted to a graphics format that the recipient's cell phone can display.

By compressing and storing handwriting data using an efficient vector format the file size is kept small to reduce transmission cost.

The server can link accurate recognition of a signature of a user with rules for transactions that are to occur based on the signature. For example, a server can verify the signatory and indicate to a third party a level of authorization associated with the recognized signature. For example, Joe Smith may only be authorized to purchase items costing less than $500, or Jim Forbes may not authorize transfers from his account.

Recognized signatures can be used as a basis for confirming, for example, information given in a telephone call. After the telephone conversation, the user can use the pen to confirm the subject of the call by sending a pen-written signature. The signature is processed by the server and verified (in addition to how it looks, the server may include the speed of writing in verification, which is difficult for a forger to duplicate).

The signature pen could be used for remote money management by not permitting withdrawal or transfer money over the phone, except upon receipt and recognition of the handwritten signature.

With advances in voice and video communication, completing a remote business transaction is feasible when the electronic signature is provided and verified, using the pen and an authorized server. Remote public notary functions could also be provided.

A bank can give special bank pens to selected customers. The customers can then bank remotely by giving transaction instructions using handwriting. Pen instructions are sent to the bank, authenticated and acted on. (The combination of the unique pen serial number and the customer's signature and a time stamp provide authorization for the transaction).

As shown in FIG. 13, authentication could be done at an authentication server 102 using information, received from the phone 104, including uttered information from a speaker 106 and handwritten information from the pen/tracker 108. The uttered information could be recognized using either voice recognition (to identify the speaker by voice characteristics) or by speech recognition.

A large company may issue electronic pens to its employees. Each pen has a unique number that identifies its user. Employees use the pens to send e-mails, messages, or requests, throughout the company's intranet. The meeting notes can be sent instantly to the intended recipients. A meeting, which used to be a decision-making process, becomes an action-taking process. The server may have lists of pen pals, departments, and top brass so sending information is easy. The user may specify, for example: “send to my department” and all employees in his department will get it.

The pen and server can be used as an Internet collaboration tool. A user writes on paper and through the Internet his message is displayed on any computer with an Internet connection. This is similar to Microsoft NetMeeting but instead of a keyboard the user can use a pen.

Cell Phone User Interface

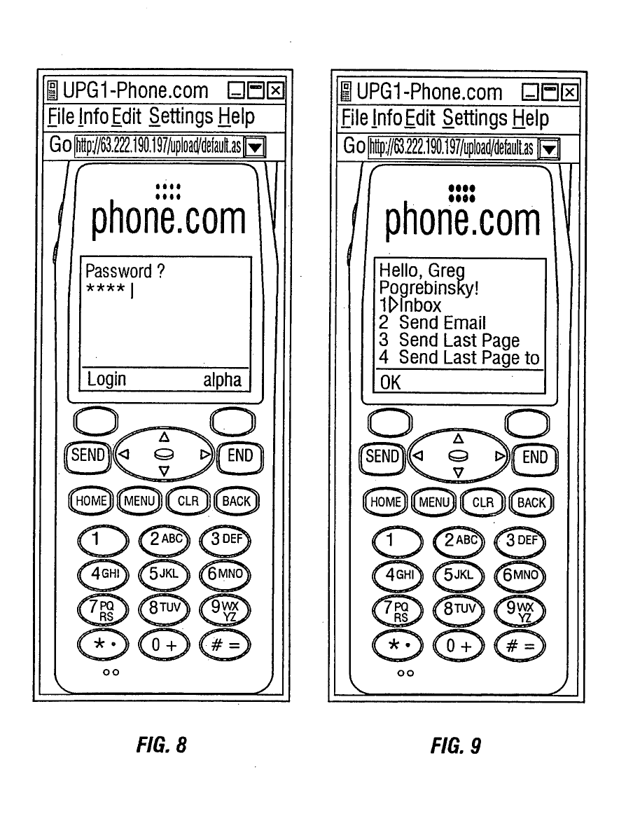

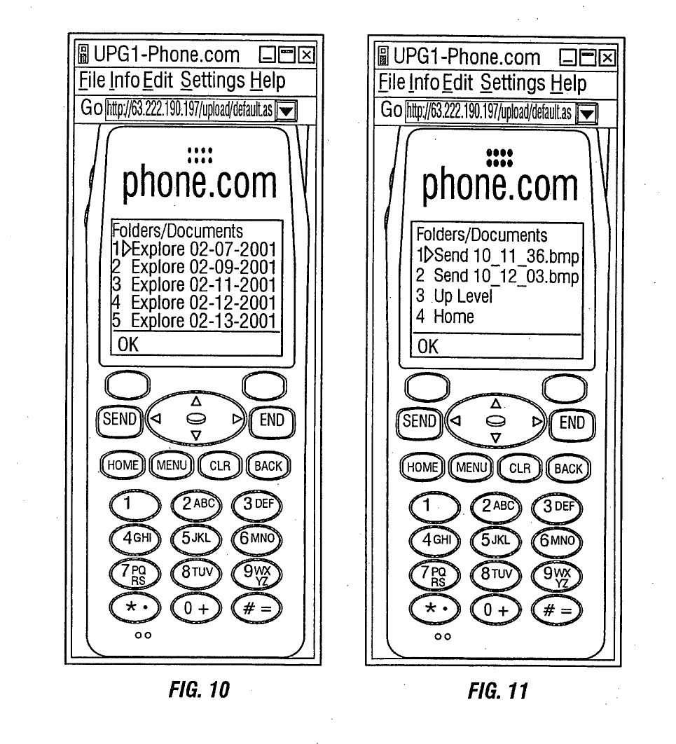

By way of example, in FIG. 6, the introductory screen of the user interface that is displayed on the screen of a cell phone includes a welcome line and a choice between “login” and “register”. In FIG. 7, if the user has selected login, he is invited to enter his user id. In the example he has entered “greg”. In FIG. 8, the password has been requested and entered. In FIG. 9, the user is welcomed and given a choice among “inbox’, “send email”, “send last page” and “send last page to”. In FIG. 10, after invoking the inbox, the user is shown a list of documents. Having picked the first listed document, in FIG. 11, the user is given the chance to send either of two stored .bmp files of handwriting, or to move up one level in the menu hierarchy or to move to the home page.

Handwriting Sensors in Cell Phone

As shown in FIG. 12, the sensor unit could be attached to or incorporated into the cell phone, for example on the side wall of the phone. In this approach, the user would only need to carry the pen 94 and the sensor equipped cell phone in order to be able to produce, store, and use handwritten information. When the user wished to handwrite information 96 to be uploaded to the server, he would put the cell phone on the edge of a writing surface 98 and proceed with handwriting. The handwriting data would be generated in the cell phone and then sent to the server as described above. Within the cell phone, a single processor and memory could serve both the tracking function and the cell phone functions.

FIG. 14 shows six views of a pen-equipped cell phone 208. The pen 210 can be stored in a pen well 212 that is accessible at one end of the phone. Sensors 214, 216 of the tracker module can be seen on one side wall of the phone. Pads 218 on the bottom of the phone enable it to resist slipping on a surface when it is placed there for purposes of capturing handwriting. The tracking module can be built into the phone or can be provided as a module that plugs into the phone or is permanently built in to the phone.

As shown in FIG. 15, in an illustrative use, the pen 210 is withdrawn from the cell phone 208. The cell phone is placed on a writing surface, and the pen is used to sketch a map 230. The map is captured as handwriting by the sensors of the embedded tracker. The cell phone then dials a number of the server. Later, at a different location, a cell phone 240 rings, receives the map and displays it 232.

The server can provide a service that helps to retrieve a stolen or lost pen. The user notifies the server that the pen has been stolen. Later when handwriting data associated with the identified pen is received at the server, the server may send a reply message indicating that the pen has been stolen and that a reward is offered for its safe return. Other actions might also be taken, such as alerting the owner that handwriting from the lost or stolen pen has been received.

Other implementations are also within the scope of the following claims.

1. A method comprising
receiving handwriting data electronically from a remote user at a handwritten-information server, and
processing the handwriting data in accordance with instructions provided to the server by the user.

2. The method of claim 1 in which the handwriting data is generated using a handwriting device at the location of the remote user.

3. The method of claim 1 in which the handwriting data is generated by an electronic wireless pen.

4. The method of claim 1 also including
performing handwriting recognition at the site of the remote user.

5. The method of claim 1 also including
performing handwriting recognition at the handwritten-information server.

6. The method of claim 1 also including
at the location of the remote user, forming an electronic file representing the handwritten information,
transmitting the handwritten information wirelessly to a communication device, and
transmitting the electronically captured handwriting from the communication device to the handwritten-information server.

7. The method of claim 1 in which the handwriting data includes information identifying a destination of the handwriting data.

8. The method of claim 1 in which the processing of the handwriting data includes forwarding it to a destination.

9. The method of claim 8 in which the forwarding comprises sending the handwriting data in FAX format.

10. The method of claim 8 in which the forwarding comprises sending the handwriting data as an email attachment or in a body of an email.

11. A method comprising
using a tracker attached to a mobile personal digital assistant having wireless communication capability, tracking handwriting done on a writing surface in the vicinity of the personal digital assistant,
sending handwriting data representing the handwriting wirelessly from the personal digital assistant to a server, and
providing services to a user from the server with respect to the handwriting data.

12. A method comprising
storing, in a server, handwriting information provided wirelessly from mobile devices, and
communicating the handwriting to destinations based on instructions provided by users.

13. A method comprising
storing in a server handwriting information received wirelessly from mobile devices, and
providing an interactive user interface on a screen of a mobile device to enable a user to control functions applied to the handwriting information.

14. A method comprising
capturing handwriting of a name of an addressee of a message as handwriting data representing motion that occurred during the handwriting,
communicating the handwriting data to a server,
at the server, determining the name from the handwriting data using information stored in a database.

15. The method of claim 14 also including asking a user for confirmation of the located address.

16. The method of claim 14 also including sending the message to the located address.

17. The method of claim 14 in which the database includes information provided by a user, the information in the database linking names with corresponding addresses.

18. A method comprising
from a server, communicating handwriting data to remote user devices, the handwriting data for each of the devices being formatted according to display capabilities of the remote user device.

19. A method comprising
receiving at a server handwriting data representing a signature of a user of a remote device,
verifying the signature based on handwriting data associated with the user and stored on the server, and
authorizing a transaction based on the verification of the signature.

20. The method of claim 19 in which the authorizing includes providing an authorization to a third party.

21. The method of claim 19 in which the transaction is associated with a financial account of the user.

22. The method of claim 19 in which the receipt of the handwriting data occurs after terms of the transaction have been resolved.

23. The method of claim 19 in which the authorization is also based on a unique identifier of a pen that is used to write the signature.

24. The method of claim 19 also including authorizing the transaction based on voice or speech recognition.

25. The method of claim 19 also including authorizing the transaction based on a time stamp.

26. A method comprising
receiving and storing at a server handwriting information that is created by users at remote locations and communicated electronically to the server,
electronically performing services with respect to the stored information, and
charging the users for the services performed.

27. A method comprising
receiving, at a server, handwriting data from a pen and a pen identifier,
storing, at a server, an indication that the pen is in the possession of a person not authorized to use it, and
in response to the received handwriting data and pen identifier, determining that the pen is not being used by an authorized person, and
taking an action in accordance with the result of the matching.

28. A method comprising
receiving electronic handwriting data created by a user's handwriting,
receiving instructions indicating visible qualities to be associated with respective portions of the handwriting, and
manifesting the handwriting in a visible form in which each of the respective portions of the handwriting is manifested in accordance with the indicated visible qualities.

29. The method of claim 28 in which the visible qualities include color.

30. The method of claim 28 in which the instructions are received from a handwriting instrument.

31. A method comprising
associating unique identifiers with respective electronic handwriting devices that are useful in generating handwriting data,
in a server, storing the handwriting data and storing associations between the unique identifiers of the devices and registered unique identifiers of respective users, and
at the server, controlling use of the handwriting data based on matching stored pairs of user identifiers and device identifiers to confirm that the purported user of a device used to generate the handwriting data is the registered user of the device.

32. Apparatus comprising
a mobile electronic device that includes
a communication facility configured to communicate with a remote location, and
a tracking facility configured to track handwriting motion of a stylus on a surface in a vicinity of the mobile electronic device.

33. The apparatus of claim 32 in which the mobile electronic device comprises a mobile telephone.

34. The apparatus of claim 32 in which the mobile electronic device includes a housing and the tracking facility is incorporated within the housing.

35. The apparatus of claim 32 in which the mobile electronic device includes a housing and the tracking facility is attached to the housing.

36. The apparatus of claim 32 in which the mobile electronic device includes a receptacle for a stylus.
